(19) United States
(12) Patent Application Publication
(10) Pub. No.: US 2020/0388972 A1
(43) Pub. Date: Dec. 10, 2020

(54) ELECTRICAL DISTRIBUTION UNIT WITH RETRACTABLE CORD

(71) Applicants: Norman R. Byrne, Ada, MI (US); Ryan J. Alt, Byron Center, MI (US)

(72) Inventors: Norman R. Byrne, Ada, MI (US); Ryan J. Alt, Byron Center, MI (US)

(21) Appl. No.: 16/895,666

(22) Filed: Jun. 8, 2020

Related U.S. Application Data
(60) Provisional application No. 62/859,000, filed on Jun. 8, 2019.

(51) Int. Cl. H01R 25/00; H01R 13/66; H01R 13/516; H01R 31/06; H01R 24/76; H02G 11/02

(52) U.S. Cl. CPC H01R 25/006; H01R 13/665; H02G 11/02; H01R 31/06; H01R 24/76; H01R 13/516

(57) ABSTRACT

An electrical distribution unit includes a support housing and a device charging module in the support housing, the device charging module including a retractable cord and a repositionable electrical connector that can be used to supply charging power and/or electronic data to a portable electronic device in various locations within a vicinity of the electrical distribution unit. An electrical receptacle is also mounted to the support housing adjacent the device charging module. The repositionable electrical connector and retractable cord are extendable and retractable relative to a housing of the device charging module as desired by a user.

### CROSS REFERENCE TO RELATED APPLICATION

The present application claims the benefit of U.S. provisional application Ser. No. 62/859,000, filed Jun. 8, 2019, which is hereby incorporated by reference in its entirety.

### FIELD OF THE INVENTION

The present invention relates to low voltage electrical power and/or data outlets or receptacles for use in work areas or the like.

### BACKGROUND OF THE INVENTION

Electrical charging and data outlets, cords, and plugs are in increasing demand as the number of electrical and electronic devices that use such outlets, cords, and plugs continues to increase. Such devices may include, for example, mobile phones, computers and computing devices, digital cameras, communications equipment, and the like. Such devices are typically equipped with an onboard battery or other rechargeable power source, and an electrical and/or data receptacle that can be used to recharge the device's battery and, optionally, to exchange electronic data with the device.

### SUMMARY OF THE INVENTION

The present invention provides an electrical distribution unit that includes a device charging module including a retractable cord fitted with at least one electrical connector that can be drawn outwardly from a housing of the module, and which can be retracted into the module. This allows for charging and/or exchanging electronic data with a portable electronic device that can be rested on other surfaces or used in the general vicinity of the charging module while it is connected to the retractable cord's connector. The device charging module may itself include a separate low voltage DC receptacle, such as a USB-A or USB-C receptacle, and may further include a power transformer for reducing a line voltage (e.g., 110V AC or 220V AC), that supplies electrical power to standard receptacle outlets, down to a lower voltage (such as about 2V DC to about 12V DC, for example), which is made available at the retractable cord's connector(s) and at a separate low voltage DC receptacle, if so equipped.

According to one form of the present invention, an electrical distribution unit includes a support housing, a device charging module mounted to the support housing, and an electrical receptacle mounted to the support housing adjacent the device charging module. The device charging module includes a module housing, a retractable cord disposed in the module housing; a repositionable electrical connector at an end of the retractable cord, and a fixed low voltage DC power outlet positioned adjacent the repositionable electrical connector. The repositionable electrical connector and the retractable cord are extendable and retractable relative to the module housing, and are configured to convey charging power or electronic data signals to a portable electronic device, such as when the repositionable electrical connector and the retractable cord are extended from the module housing.

In one aspect, the electrical receptacle includes a high voltage AC receptacle, and the device charging module includes an electrical power converter circuit for receiving a high voltage AC power input associated with the high voltage AC receptacle, for providing a low voltage DC power output to the retractable cord and to the repositionable electrical connector.

In another aspect, a cord retractor assembly is positioned in the module housing and functions to selectively retract the retractable cord into the module housing.

In yet another aspect, the cord retractor assembly includes a connector housing with a front edge defining an opening for selectively receiving the repositionable electrical connector. The module housing includes a front housing piece that is positioned in front of the cord retractor assembly. There is an electrical connector opening formed in the front housing piece, for receiving the repositionable electrical connector. The opening defined by the front edge of the connector housing aligns with the electrical connector opening of the module housing.

In a still further aspect, the repositionable electrical connector further includes a gripping member at a distal end thereof. At least a portion of the gripping member extends forwardly of the front housing piece when the cord and the repositionable electrical connector are fully retracted.

Optionally, the repositionable electrical connector includes a connector base and a male plug connector coupled to the connector base. Optionally, the cord and the gripping member are also coupled to the connector base.

In a further aspect, the male plug connector extends laterally from the connector base and is located proximal to the gripping member. The male plug connector is received in a portion of the connector housing when the cord and the repositionable electrical connector are fully retracted. Optionally, the male plug connector is one of a plurality of interchangeable connectors, such as Lightning®, USB-A, USB-C, HDMI®, RJ-45, and the like.

Therefore, the electrical distribution unit of the present invention provides for convenient device charging and/or data connection, such as along a work surface, using a retractable cord that can be pulled out and connected to a portable electronic device that is in a location convenient to a user. The user can thus place or hold the portable device while maintaining connection to power or data, without need for supplying a separate charging cord, and permitting the retractable cord to be neatly stowed out-of-sight at the distribution unit when not in use. The distribution unit may also provide one or more high voltage AC and/or low voltage DC receptacles or data outlets, for plugging in other devices.

These and other objects, advantages, purposes and features of the present invention will become apparent upon review of the following specification in conjunction with the drawings.

### BRIEF DESCRIPTION OF THE DRAWINGS

FIG. 1 is a front perspective view of an electrical distribution unit fitted with a device charging module in accordance with the present invention;

FIG. 2 is another front perspective view of an electrical distribution unit and device charging module of FIG. 1, in which a retractable cord fitted with an electrical connector has been drawn outwardly from a front face of the device charging module;

FIG. 3 is a front perspective view of the device charging module;

FIG. 4 is another front perspective view of the device charging module, in which the retractable cord and its electrical connector are drawn outwardly from the front face of the device charging module;

FIG. 5 is an exploded front perspective view of the device charging module, viewed from the right side thereof;

FIG. 6 is an exploded rear perspective view of the device charging module, viewed from the right side thereof;

FIG. 7 is another exploded front perspective view of the device charging module, viewed from the left side thereof;

FIG. 8 is an exploded rear perspective view of the device charging module, shown in an inverted orientation and viewed from the right side thereof;

FIG. 9 is a front elevation of the device charging module;

FIG. 10 is a rear elevation of the device charging module;

FIG. 11 is a top plan view of the device charging module;

FIG. 12 is a bottom plan view of the device charging module;

FIG. 13 is a right side elevation of the device charging module; and

FIG. 14 is a left side elevation of the device charging module.

### DESCRIPTION OF THE PREFERRED EMBODIMENTS

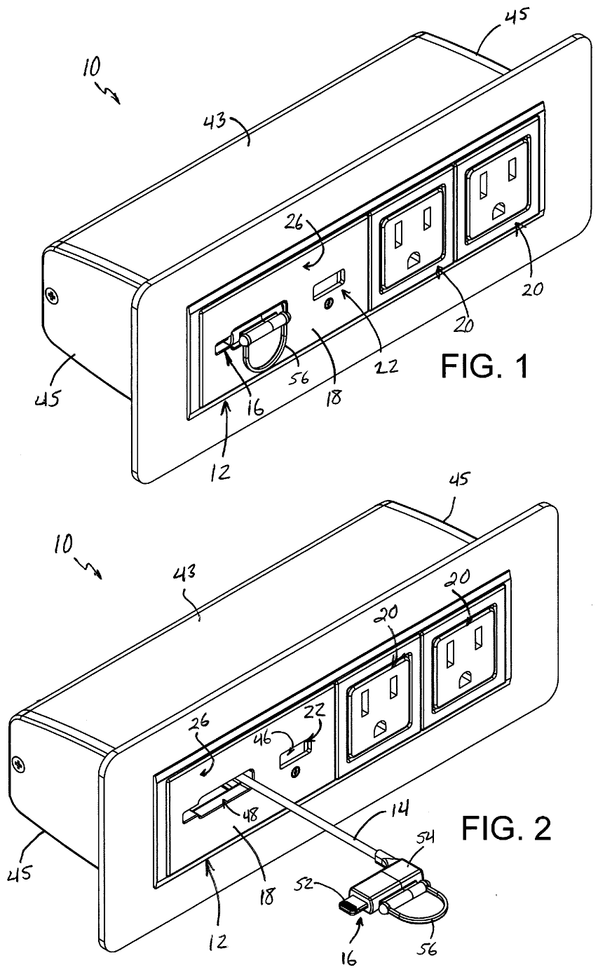

Referring now to the drawings and the illustrative embodiments depicted therein, an electrical distribution unit 10 includes a device charging module 12 having a retractable cord 14 fitted with at least one electrical connector 16 that can be drawn outwardly from a front face 18 of the module 12, such as shown in FIGS. 1 and 2. The retractable cord allows a user to charge and/or exchange electronic data with a portable electronic device, such as a smartphone, that can be rested on other surfaces or used in the general vicinity of the charging module 12 while the charging module is connected to the retractable cord's connector. In the illustrated embodiment of FIGS. 1 and 2, the electrical distribution unit 10 further supports a pair of high voltage AC simplex receptacles 20 adjacent the device charging module 12, which itself includes an additional fixed-place low voltage DC power outlet receptacle 22. The low voltage DC power outlet receptacle 22 is illustrated as a USB-A receptacle, and the electrical connector 16 is illustrated as a Lightning® charging plug, although it will be appreciated that any other type of charging receptacle or plug may be substituted for these components without departing from the spirit and scope of the present invention.

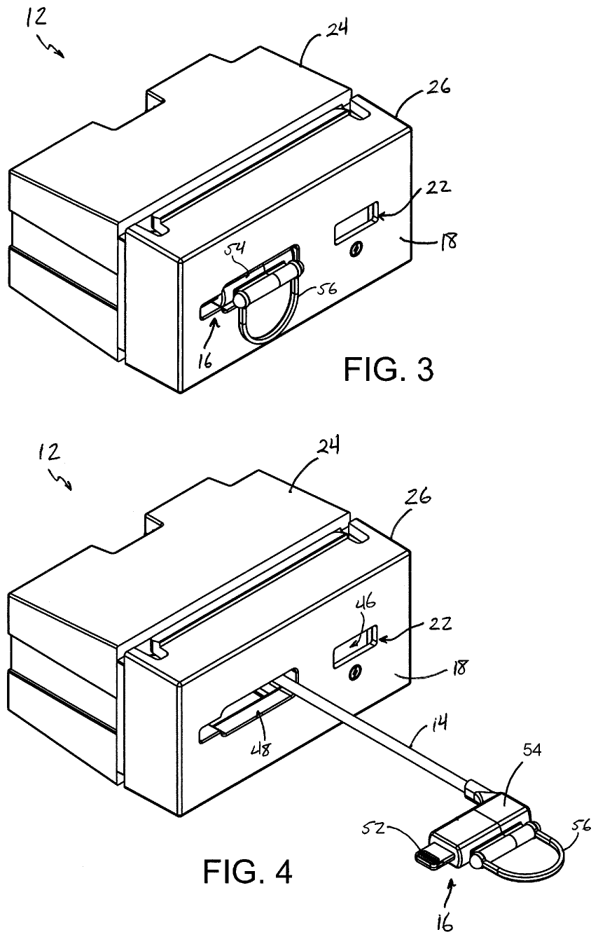

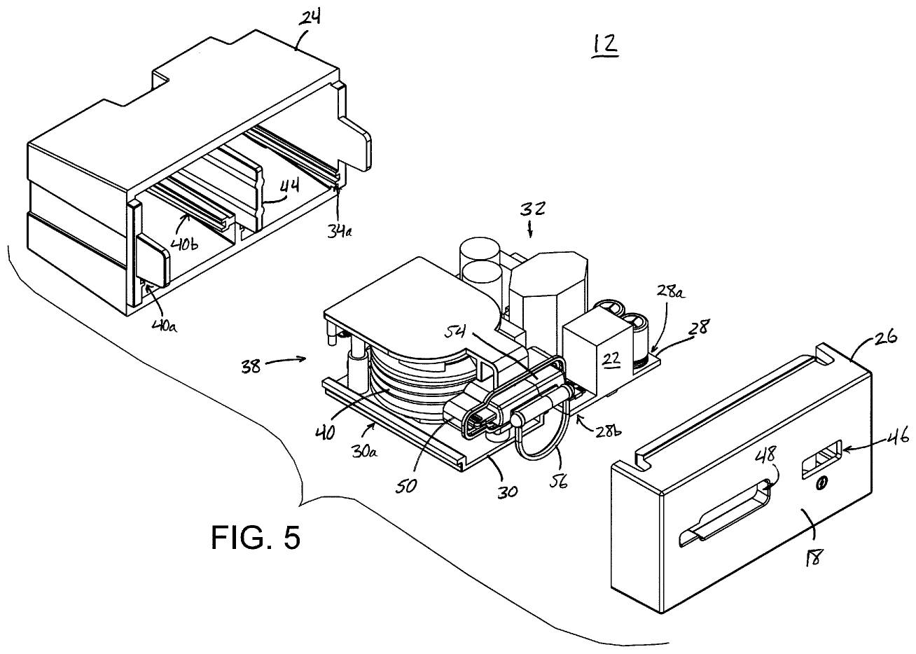

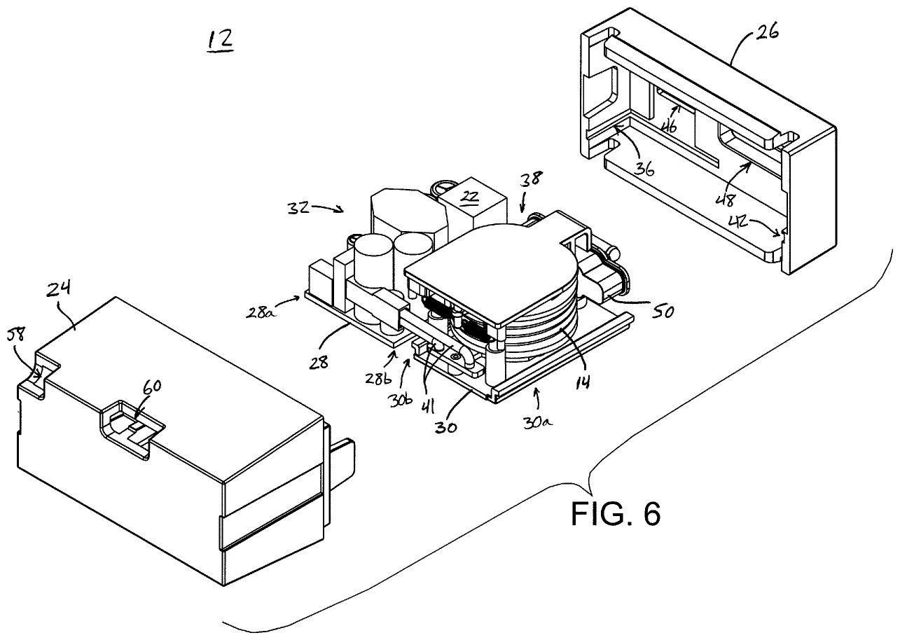

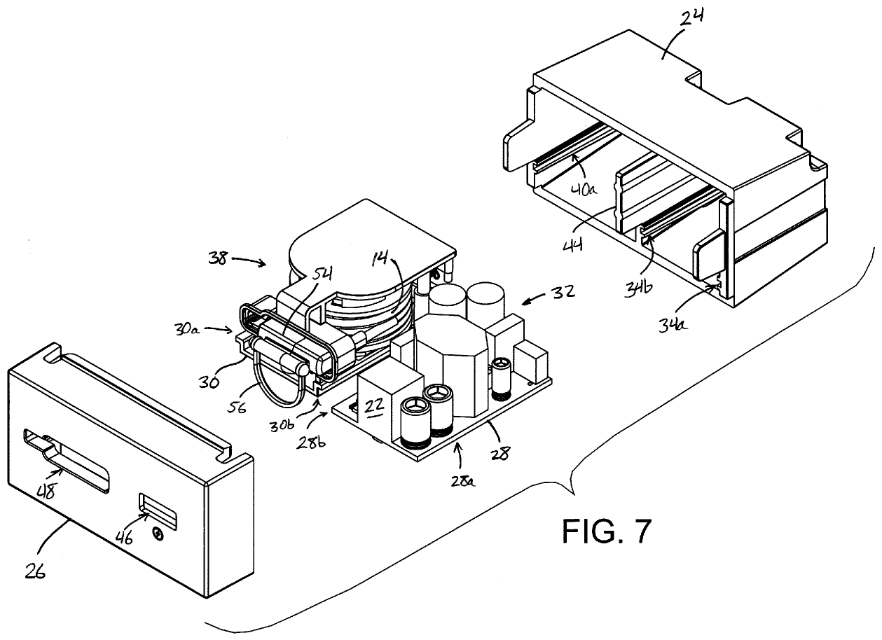

Device charging module 12 includes a two-piece housing made up of a main (rear) housing piece 24 and a front housing piece 26 that includes the front face 18, such as shown in FIGS. 3-6. Inside the housing of the device charging module 12 are a circuit board 28 and a retractor support board 30 in side-by-side arrangement. The circuit board 28 supports power converter circuitry 32 for receiving a high voltage AC power input and for outputting a lower voltage DC power output that is output to the low voltage DC power outlet receptacle 22 and the electrical connector 16. Circuit board 28 includes a left side edge portion 28a that is received in a left side slot 34a inside the rear housing piece 24 and a recess channel 36 formed inside the left and left-front portions of the front housing piece 26, such as shown in FIGS. 5 and 6. The circuit board 28 further includes a right side edge portion 28b that is received in a left-central slot 34b inside the rear housing piece 24, such as shown in FIGS. 6 and 7. Similarly, retractor support board 30 supports a cord or wire retractor assembly 38 that winds and unwinds retractable cord 14, and includes a right side edge portion 30a that is received in a right side slot 40a inside the rear housing piece 24 and a recess channel 42 formed inside the right interior side portion of the front housing piece 26, such as shown in FIGS. 6-8. The retractor support board 30 further includes a left side edge portion 30b that is received in a right-central slot 40b inside the rear housing piece 24, such as shown in FIG. 5.

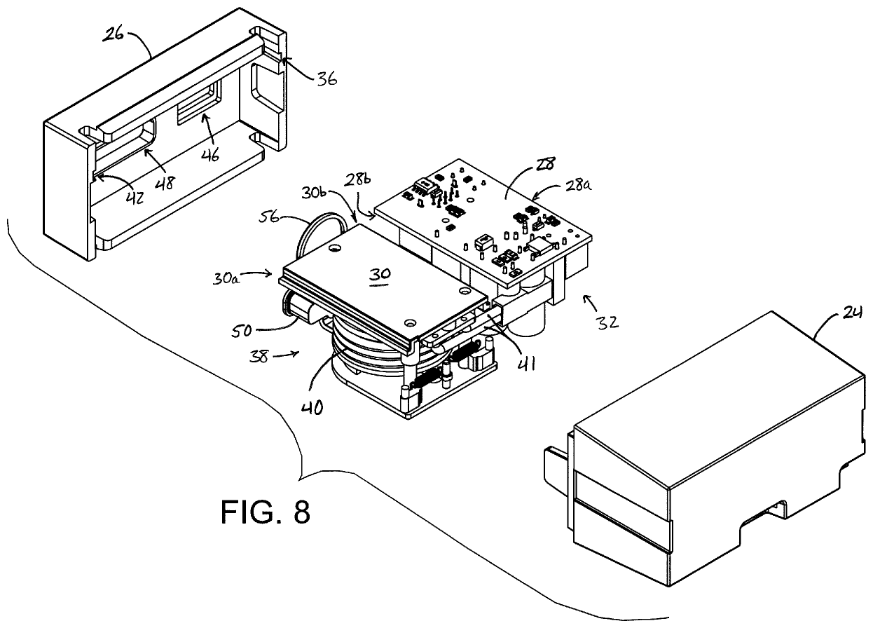

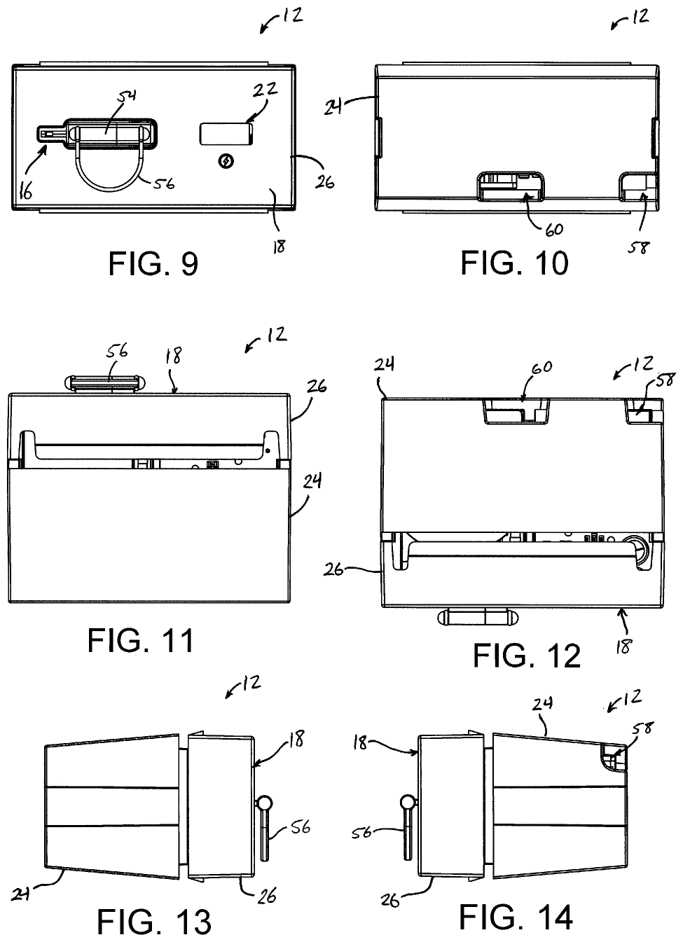

Inside the rear housing piece 24, a vertical divider wall 44 projects forwardly from a rear wall, at and above the left-central slot 34b and right-central slot 40b (FIGS. 5 and 7), and serves to isolate the wire retractor assembly 38 and cord 14 on the retractor support board 30 from the power converter circuitry 32 on the circuit board 28. In the event of a retractor malfunction or other event that results in the cord 14 or other structure associated with the retractor assembly 38 moving out of its normal arrangement, the divider wall 44 prevents components of the retractor assembly 38 from contacting or otherwise interfering with the power converter circuitry 32. Referring to FIGS. 6 and 8, in the illustrated embodiment, before assembly of the device charging module 12, the only direct connection between the retractor support board 30 the circuit board 28 is by a pair of low voltage DC power wires 41 of opposing polarity, which carry low voltage DC current from the power converter circuitry 32 to the wire retractor assembly 38, which directs the power to the power cord 14 and power connector 16. Various other details regarding the mounting of circuit board 28 and retractor support board 30, and the mounting of the front and rear housing pieces 24, 26 to an extruded channel housing 43 having a pair of end caps 45 (FIGS. 1 and 2), may be more fully understood with reference to commonly-owned U.S. Pat. No. 9,312,673, entitled “LOW VOLTAGE POWER RECEPTACLE,” which is hereby incorporated herein by reference in its entirety.

The front face 18 of the front housing piece 26 defines a DC receptacle opening 46 that is positioned directly in front of (and provides access to) the fixed-place low voltage DC power outlet receptacle 22, and a charging plug opening 48 that is positioned directly in front of the retractor assembly 38 and is shaped to at least partially receive the charging plug 16 such as shown in FIGS. 1, 3, 5 and 7. The retractor assembly 38 includes a connector “cage” or housing 50 that has a shape generally corresponding to that of charging plug opening 48, and is aligned therewith. Connector housing 50 receives the charging plug 16 when the cord 14 is fully retracted, such as shown in FIGS. 5 and 7, and includes a small rear opening (not shown) through which the cord 14 is fed during extension and retraction of the cord 14 by the retractor assembly 38. A front edge 50a of the connector housing 50 may contact an inner surface of the front housing piece 26 surrounding the charging plug opening 48, and optionally form a seal therewith, to limit or prevent the intrusion of contaminants through the charging plug opening 48.

Charging plug 16 includes a male plug connector 52 projecting from a connector base 54 to which the flexible cord 14 is connected, with a gripping member in the form of a pivotable pull-ring 56 attached to a front surface of the connector base 54 such as shown in FIGS. 2 and 4. As mentioned above, male plug connector 52 may be a USB-C or Lightning® plug connector for charging only, or may provide electronic data connectivity. Substantially any style of power and/or data plug connector or receptacle may be substituted for the illustrated Lightning® plug connector shown, without departing from the spirit and scope of the present invention. Optionally, the male plug connector 52 is replaceable with other styles of connector at the connector base 54, so that a desired connector, selected from a group of interchangeable connectors, may be readily installed without disassembling the device charging module 12. It is further envisioned that multiple different male plug connectors could be provided along the connector base, so that the charging plug is compatible with most portable electronic devices that are commonly in use at any given time. The pivotable pull-ring 56 remains at least partially outside of the front housing piece 26 at all times, and can be engaged by a user's finger to pull the plug connector 52 and cord 14 out from the retractor assembly 38. The pull-ring 56 can be lowered as shown in FIGS. 1 and 3 to be directly in front of a portion of the front housing piece's front face 18.

The retractor assembly 38 includes a coil spring or motorized winder for winding the cord 14 on a spool of the retractor, and permitting the cord 14 to be payed out of the retractor for use, and permitting the cord 14 to be used without a retraction force until the user desires the cord to be retracted, which may be accomplished by pulling gently on the cord after an initial payout and release of the cord. Suitable retractor assemblies, including cords and plug connectors, are available from DataComm Electronics, Inc. of Norcross, Ga.

Electrical power is supplied to the electrical distribution unit 10, including to the power converter circuitry 32, the low voltage DC power receptacle 22, and the high voltage AC power receptacles 20, via a conventional high voltage AC power cord with male plug end (not shown). The power cord enters channel housing 43 and then passes through rear housing piece 24 via an opening such as one of the openings 58, 60 shown in FIGS. 6, 10, 12 and 16. Optionally, low voltage DC electrical power may be supplied directly through the rear housing piece 24 to obviate the need for the power converter circuitry 32 inside the housing.

Accordingly, the electrical distribution unit with device charging module of the present invention provides users with convenient access to charging power and/or electronic data transmission via a retractable cord that stays with the electrical distribution unit. The electrical distribution unit may further provide users with access to high voltage AC electrical outlets and/or to low voltage DC electrical outlets. When the cord and its connector are not in use, the cord retracts fully into the housing of the device charging module, while at least a portion of the plug connector remains accessible at a front surface of the device charging module.

Changes and modifications in the specifically-described embodiments may be carried out without departing from the principles of the present invention, which is intended to be limited only by the scope of the appended claims as interpreted according to the principles of patent law including the doctrine of equivalents.

The embodiments of the invention in which an exclusive property or privilege is claimed are defined as follows:

1. An electrical distribution unit comprising:
a support housing;
a device charging module comprising:
a module housing configured to be mounted at said support housing;
a retractable cord disposed at least partially within said module housing;
a repositionable electrical connector at a distal end of said retractable cord; and
a fixed low voltage DC power outlet positioned adjacent said repositionable electrical connector; and
an electrical receptacle mounted to said support housing adjacent said device charging module;
wherein said repositionable electrical connector and said retractable cord are extendable and retractable relative to said module housing, and are configured to convey charging power or electronic data signals to a portable electronic device when said repositionable electrical connector and said retractable cord are in an extended configuration.

2. The electrical distribution unit of claim 1, wherein said electrical receptacle comprises a high voltage AC receptacle, and said device charging module comprises an electrical power converter circuit configured to receive a high voltage AC power input associated with said high voltage AC receptacle, and to provide a lower voltage DC power output to said retractable cord and said repositionable electrical connector.

3. The electrical distribution unit of claim 2, further comprising a cord retractor assembly positioned in said module housing and operable to selectively retract said retractable cord into said module housing.

4. The electrical distribution unit of claim 3, wherein said cord retractor assembly comprises a connector housing having a front edge defining an opening for selectively receiving said repositionable electrical connector, and said module housing comprises a front housing piece positioned in front of said cord retractor assembly, said module housing defining an electrical connector opening for selectively receiving said repositionable electrical connector, and wherein said opening defined by said front edge of said connector housing is aligned with said electrical connector opening of said module housing.

5. The electrical distribution unit of claim 4, further comprising a gripping member at a distal end of said repositionable electrical connector, wherein at least a portion of said gripping member extends forwardly of said front housing piece when said cord and said repositionable electrical connector are fully retracted with said repositionable electrical connector received in said connector housing.

6. The electrical distribution unit of claim 5, wherein said repositionable electrical connector comprises a connector base and a male plug connector coupled to said connector base, and said cord and said gripping member are coupled to said connector base.

7. The electrical distribution unit of claim 6, wherein said male plug connector projects laterally from said connector base and is located proximal to said gripping member, wherein said male plug connector is received in a portion of said connector housing when said cord and said repositionable electrical connector are fully retracted.

8. An electrical distribution unit comprising:
a support housing;
a device charging module comprising:
a module housing;
a retractable cord disposed at least partially within said module housing; and
a repositionable electrical connector at a distal end of said retractable cord;
wherein said module housing is configured to be mounted at said support housing; and
an electrical receptacle mounted to said support housing adjacent said device charging module;
wherein said repositionable electrical connector and said retractable cord are extendable and retractable relative to said module housing, and are configured to convey charging power or electronic data signals to a portable electronic device when said repositionable electrical connector and said retractable cord are in an extended configuration.

9. The electrical distribution unit of claim 8, wherein said device charging module comprises an electrical power converter circuit configured to receive a high voltage AC power input and to provide a lower voltage DC power output to said retractable cord and said repositionable electrical connector.

10. The electrical distribution unit of claim 9, wherein said device charging module comprises a fixed low voltage DC power outlet positioned adjacent said repositionable electrical connector when said repositionable electrical connector and said retractable cord are in a retracted configuration.

11. The electrical distribution unit of claim 8, further comprising a cord retractor assembly positioned in said module housing and operable to selectively retract said retractable cord into said module housing.

12. The electrical distribution unit of claim 11, further comprising a low voltage DC power receptacle positioned in said module housing adjacent said cord retractor assembly.

13. The electrical distribution unit of claim 12, further comprising an electrical power converter circuit positioned in said module housing, wherein said converter circuit is operable to receive a high voltage AC power input and to direct a lower voltage DC power output to said low voltage DC power receptacle and to said repositionable electrical connector.

14. The electrical distribution unit of claim 13, wherein said module housing comprises a divider wall disposed between said cord retractor assembly on one side thereof, and said low voltage DC power receptacle and said converter circuit on another side thereof.

15. The electrical distribution unit of claim 11, wherein said cord retractor assembly comprises a connector housing having a front edge defining an opening for selectively receiving said repositionable electrical connector.

16. The electrical distribution unit of claim 15, wherein said module housing comprises a front housing piece positioned in front of said cord retractor assembly, wherein said module housing defines an electrical connector opening for selectively receiving said repositionable electrical connector, and wherein said opening defined by said front edge of said connector housing is aligned with said electrical connector opening of said module housing.

17. The electrical distribution unit of claim 16, further comprising a gripping member at a distal end of said repositionable electrical connector, wherein at least a portion of said gripping member extends forwardly of said front housing piece when said cord and said repositionable electrical connector are fully retracted with said repositionable electrical connector received in said connector housing.

18. The electrical distribution unit of claim 17, wherein said repositionable electrical connector comprises a connector base and a male plug connector coupled to said connector base, and said cord and said gripping member are coupled to said connector base.

19. The electrical distribution unit of claim 18, wherein said male plug connector projects laterally from said connector base and is located proximal to said gripping member, wherein said male plug connector is received in a portion of said connector housing when said cord and said repositionable electrical connector are fully retracted.

20. The electrical distribution unit of claim 18, wherein said male plug connector is replaceable at said connector base, and is interchangeable with other male plug connectors.
